(19) United States
(12) Patent Application Publication
(10) Pub. No.: US 2017/0183550 A1
(43) Pub. Date: Jun. 29, 2017

(54) Reactive Polyurethane Hot Melt Adhesive and the Use Thereof

(71) Applicant: Henkel AG & Co. KGaA, Duesseldorf (DE)

(72) Inventors: Ming Hsiao Sun, Shanghai (CN); Claudia Meckel-Jonas, Duesseldorf (DE)

(21) Appl. No.: 15/461,983

(22) Filed: Mar. 17, 2017

Related U.S. Application Data
(63) Continuation of application No. PCT/CN2014/087496, filed on Sep. 26, 2014.

(51) Int. Cl. C09J 175/06; C09J 5/00; A43B 13/32; D06N 3/14; A43B 9/12; A43D 25/20; C08G 18/42; C08G 18/76

(52) U.S. Cl. CPC C09J 175/06; C08G 18/4213; C09J 5/00; C08G 18/4216; C08G 18/4238; C08G 18/7671; D06N 3/146; D06N 3/147; A43B 9/12; A43D 25/20; A43B 13/32; C08G 2170/20; C09J 2475/00; D06N 2203/068; D06N 2211/106; D10B 2501/043

(57) ABSTRACT

The present invention relates to a reactive polyurethane hot melt adhesive and the use thereof. In particular, the present invention relates to a reactive polyurethane hot melt adhesive providing higher initial tack, better elasticity, better recovery and lower malodor.

### TECHNICAL FIELD

The present invention relates to a reactive polyurethane hot melt adhesive and the use thereof. In particular, the present invention relates to a reactive polyurethane hot melt adhesive having good elasticity, good recovery and low malodor.

### BACKGROUND

Reactive polyurethane hot melt adhesives have been widely used in the application between fabric and fabric, fabric and foam lamination, such as in the underwear or sportswear manufacturing field to replace sewing and heat sealing tapes, simplify processes, save costs, reduce lead time, and obtain more competitive products in the market.

These adhesives consist primarily of isocyanate terminated polyurethane prepolymers that react with a surface or ambient moisture in order to extent the backbone and thus form a polyurethane polymer. Polyurethane prepolymers are conventionally obtained by reacting diols with diisocyanates. Through the diffusion of moisture from the atmosphere or the substrates into the adhesive and subsequent reaction, the polyurethane prepolymers cure under atmosphere conditions. The obtained adhesive product is a crosslinked material primarily bonded through urea groups and urethane groups. Reactive hot-melt adhesives based on isocyanate-terminated polyurethane prepolymers are described for example by H. F. Hüuber and H. Müller in “Shaping Reactive Hotmelts Using LMW Copolyesters”, Adhesives Age, November 1987, pages 32 to 35. Suitable reactive polyurethane hot melt adhesives for bonding various materials in underwear or sportswear manufacturing field are already known.

US 2004/0079482 A1 discloses a moisture cured reactive hot melt adhesive comprising monofunctional reactants as grafting agents and polymeric polyols which may be polyether polyols. Such adhesives have good green strength and maintain fast setting and crosslinkability.

U.S. Pat. No. 5,599,895 A discloses a moisture-curing polyurethane hot-melt adhesive composition, comprising at least one polyalkylene glycol, preferably polypropylene glycol with an average molecular weight between about 250 and 1000. It is reported that by adding such polyalkylene glycols, high initial strength, high creep resistance and good flow characteristics are obtained.

Likewise, U.S. Pat. No. 5,965,662 A discloses a moisture-curing polyurethane hot melt adhesive comprising at least one polyalkylene glycol and at least one chain extender. A polypropylene glycol with an average molecular weight between about 100 and 1000 is preferred to improve high initial strength, high creep resistance and good flow characteristics. It is reported that the addition of the chain extender improves creep resistance in the sole bonding phase immediately after pressing and before the setting of adhesive.

EP 0369607 A1discloses a quick-setting hot-melt polyurethane composition comprising a polyether based polyurethane prepolymer and a polyester based polyurethane prepolymer. It is reported that such hot-melt polyurethane composition provides a fast-setting adhesive curing with atmospheric moisture to give flexible bonding over a wide temperature range and avoids the hydrolytic degradation to which polyester polyurethanes are susceptible.

U.S. Pat. No. 8664330 B2 discloses a moisture curable polyurethane hot melt adhesive composition having improved hydrolysis resistance. It is reported that such adhesive composition may also contain polyether polyols.

US 2004/0072952 A1 discloses a polyurethane hot melt adhesive composition comprising an isocyanate, an effective amount of a non-polymeric aromatic diol and, optionally, a polyether diol, polyester diol and/or plastic. In all of the examples of the application, polypropylene glycols are used in the adhesive compositions.

Therefore, polyether polyols, such as polyalkylene glyols are conventionally used in the reactive polyurethane hot melt adhesive in prior art. However, the inventors of the present invention surprisingly found that the existence of a significant amount of polyether polyols deteriorates initial tack, elasticity and recovery, and causes malodor whereas the reactive polyurethane hot melt adhesive compositions according to the present invention are capable of providing higher initial tack, better elasticity, better recovery and lower malodor, which constitutes the present invention accordingly.

### SUMMARY OF THE INVENTION

Disclosed herein is a reactive polyurethane hot melt adhesive composition comprising at least one polyurethane prepolymer, said polyurethane prepolymer comprises the reaction product of the reactants: a) at least one polyisocyanate, b) at least one non-linear polyester polyol, and c) from 0 to about 10% by weight of a polyalkylene glycol based on the total weight of said polyurethane prepolymer.

Also disclosed herein is the use of the reactive polyurethane hot melt adhesive composition according to the present invention for bonding articles having substrates made of wood, metal, polymeric plastics, glass and textiles; for bonding to exterior surfaces, as a glazing compound in the manufacture of windows, in the manufacture of doors and architectural panels, or in the manufacture of footwear and garments.

Also disclosed herein is a footwear or garment comprising a cured adhesive obtained from the reactive polyurethane hot melt adhesive according to the present invention.

Also disclosed herein is a method of making a footwear or garment comprising a first substrate and a second substrate, said method comprising: i) applying the reactive hot melt adhesive composition according to the present invention in a liquid form to the first substrate; ii) bringing a second substrate in contact with the composition applied to the first substrate; and iii) allowing the reactive hot melt adhesive composition to cure by moisture.

Other features and aspects of the subject matter are set forth in greater detail below.

### DETAILED DESCRIPTION

It is to be understood by one of ordinary skill in the art that the present discussion is a description of exemplary embodiments only, and is not intended as limiting the broader aspects of the present invention.

In one aspect, the present invention is generally directed to a reactive polyurethane hot melt adhesive composition comprising at least one polyurethane prepolymer, said polyurethane prepolymer comprises the reaction product of the reactants: a) at least one polyisocyanate, b) at least one non-linear polyester polyol, and c) from 0 to about 10% by weight of a polyalkylene glycol based on the total weight of said polyurethane prepolymer.

As used herein, the term “a polyurethane prepolymer” is understood to be an oligourethane having isocyanate groups which is to be regarded as an intermediate on the way to the crosslinked polyurethanes.

In one embodiment, the polyurethane prepolymer according to the present invention has a NCO/OH ratio, which is calculated by dividing the molar amount of NCO groups of the polyisocyanates by the molar amount of OH groups of the polyols, of more than about 1, preferably from about 1.5 to about 2.5, more preferably from about 1.7 to about 2.2.

In one embodiment, the polyurethane prepolymer according to the present invention has a NCO content of from about 1.0 to about 3.0% by weight, preferably from about 1.5 to about 2.6% by weight based on the total weight of the polyurethane prepolymer.

As used herein, the term “NCO content” is to be understood as the percentage by weight of free NCO group per 100 g of the polyurethane prepolymer. The NCO content is specifically determined by titration according to Spiegelberger's method (EN ISO 11909).

According to the present invention, the polyurethane prepolymer is prepared by the reaction of at least one polyisocyanate with at least one non-linear polyester polyol, more preferably the reaction of at least one diisocyanate with at least one non-linear polyester diol.

A “polyisocyanate” is understood to be a low molecular weight compound having preferably from 2 to 4 isocyanate groups. The polyisocyanates used to practice the invention include aliphatic diisocyanates, cycloaliphatic diisocyanates, aromatic diisocyanates and aliphatic-aromatic diisocyanates. Specific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-toluene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. The preferred polyisocyanate is selected from the group consisting of methylenebisphenyldiisocyanate (MDI), isophoronediisocyanate (IPDI), hydrogenated methylenebisphenyldiisocyanate (HMDI) and toluene diisocyanate (TDI), or combination thereof. Most preferably, MDI is used as the polyisocyanate. In the reactive polyurethane hot melt adhesive composition according to the present invention, the amount of the at least one polyisocyanate is from about 10% to about 40% by weight, preferably from about 15% to about 30% by weight, based on the total amount of the reactants for the polyurethane prepolymer.

According to the present invention, linear diols are used for forming the linear polyester polyols and/or non-linear polyester polyols. As used herein, “a linear diol” refers to a diol in which two terminal hydroxyl groups are separated by a linear unsubstituted saturated carbon chain, i.e. by a chain of —(CH₂)— groups. Preferred are linear diols having from 2 to 8 carbon atoms selected from the group consisting of ethylene glycol, diethylene glycol, 1,3-propanediol, 1,4-butanediol, 1,5-pentanediol, 1,6-hexanediol, and mixtures thereof.

According to the present invention, linear dicarboxylic acids are used for forming the linear polyester polyols and/or non-linear polyester polyols. As used herein, “a linear dicarboxylic acid” refers to a diacid in which two terminal carboxyl groups are separated by a linear unsubstituted saturated carbon chain, i.e. by a chain of —(CH₂)— groups. Preferred are the linear dicarboxylic acids having from 2 to 12 carbon atoms selected from the group consisting of adipic acid, pimelic acid, suberic acid, azelaic acid, sebacic acid, 1,11-undecandicarboxylic acid, 1,12-dodecandicarboxylic acid, and mixtures thereof. The corresponding acid anhydrides, acid chlorides and acid esters can likewise be used.

According to the present invention, non-linear polyols are used for forming the non-linear polyester polyols. As used herein, “a non-linear polyol” refers to a polyol in which two terminal hydroxyl groups are separated by a non-linear carbon structure including a branched chain structure, a cycloaliphatic structure, an aromatic structure, or combination thereof. Suitable examples of such non-linear polyols may include, but are not limited to, 1,2-propanediol, 1,3-butanediol, 1,2-butanediol, 1,2-pentanediol, 1,3-pentanediol, 1,4-pentanediol, pentanetriol, hexanetriol, octanetriol, trimethylolpropane, pentaerythritol, 2-ethylhexanediol1,4, cyclohexanediol-1,4, neopentyl glycol, methylpentanediol, naphthalenediol, benzenediol, such as catechol, resorcinol, and hydroquinone, and the like. Preferred are non-linear polyols having from 2 to 8 carbon atoms selected from the group consisting of trimethylolpropane, pentaerythritol, neopentyl glycol, methylpentanediol, and mixtures thereof. More preferred is neopentyl glycol.

According to the present invention, non-linear polycarboxylic acids are used for forming the non-linear polyester polyols. As used herein, “a non-linear polycarboxylic acid” refers to a polycarboxylic acid in which two terminal hydroxyl groups are separated by a non-linear carbon structure, including a branched chain structure, a cycloaliphatic structure, an aromatic structure, or combinations thereof. Suitable examples of such non-linear polycarboxylic acids may include, but are not limited to, phthalic acid, isophthalic acid, terephthalic acid, tetrachlorophthalic acid, dodecylmaleic acid, octadecenylmaleic acid, aconitic acid, trimellitic acid, tricarballylic acid, cyclohexane-1,2-dicarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters such as phthalic anhydride, phthaloyl chloride and the dimethyl ester of phthalic acid. Preferred non-linear polycarboxylic acids are the aliphatic and cycloaliphatic dicarboxylic acids having from 2 to 12 carbon atoms and the aromatic dicarboxylic acids having from 2 to 12 atoms. More preferably, the non-linear polycarboxylic acids having from 2 to 12 carbon atoms are selected from the group consisting of isophthalic acid, phthalic acid, terephthalic acid, and mixtures thereof. The corresponding acid anhydrides, acid chlorides and acid esters can likewise be used.

As used herein, “a non-linear polyester polyol” is to be understood as a polyester polyol obtained from the reaction of one or more polyols with one or more polycarboxylic acids, in which at least one of the polyols or polycarboxylic acids is non-linear. Preferably, the non-linear polyester polyol comprises a branched chain structure, a cycloaliphatic structure, e.g., a cyclohexyl, an aromatic structure, e.g., a benzene ring, or combinations thereof.

In one embodiment, the non-linear polyester polyol according to the present invention is a reaction product of one or more polyols having from 2 to 8 carbon atoms with one or more polycarboxylic acids having from 2 to 12 carbon atoms, in which at least one of the polyols or polycarboxylic acids is non-linear. In one particular embodiment, the non-linear polyester polyol according to the present invention is obtained from the reaction of one or more linear diols having from 2 to 8 carbon atoms with one or more non-linear polycarboxylic acids having from 2 to 12 carbon atoms. In another particular embodiment, the non-linear polyester polyol according to the present invention is obtained from the reaction of one or more non-linear polyols having from 2 to 8 carbon atoms with one or more linear dicarboxylic acids having from 2 to 12 carbon atoms. In yet another particular embodiment, the non-linear polyester polyol according to the present invention is obtained from the reaction of one or more non-linear polyols having from 2 to 8 carbon atoms with one or more non-linear polycarboxylic acids having from 2 to 12 carbon atoms.

In one particular embodiment, the at least one, preferably at least two non-linear polyester polyol is obtained as a reaction product of reactants selected from the group consisting of adipic acid, isophthalic acid, ethylene glycol; phthalic acid, neopentyl glycol; adipic acid, isophthalic acid, 1,4-butanediol; isophthalic acid, terephthalic acid, 1,4-butanediol; sebacic acid, and 1,4-butanediol, neopentyl glycol.

Commercially available non-linear polyester polyols which may be used in the present invention include, but are not limited to, HS 2F 237P (from HOKOKU), Dynacoll 7110 (from EVONIK), XCPA-320 (from XUCHUAN) and so on. While the non-linear polyester polyols can be purchased from commercial sources, they also can be synthesized by means of conventional processes well known to a person skilled in the art.

In still another embodiment of the present invention, the non-linear polyester polyols have a hydroxyl value above from about 10 to about 200, preferably from about 30 to about 120. In still another embodiment of the present invention, the linear polyester polyols have a hydroxyl value above from about 10 to about 200, preferably from about 30 to about 120. As used herein, “hydroxy value” or “OH value” refers to the number of milligrams of KOH having the same hydroxyl content as one gram of the polyol, measured according to DIN53240-2.

According to the present invention, the at least one non-linear polyester polyol in the reactants is present in an amount of from about 40% to about 90% by weight, preferably from about 70% to about 85% by weight, based on the total amount of the reactants for polyurethane prepolymer.

In another embodiment of the present invention, the reactants for the polyurethane prepolymer of the adhesive composition according to the present invention may optionally comprise at least one linear polyester polyol.

As used herein, “a linear polyester polyol” is to be understood as polyester polyols in which the ester groups and the terminal OH groups are connected by linear unsubstituted saturated carbon chains, i.e. by chains of —(CH₂)— groups. They may be obtained from the reaction of one or more linear diols having from 2 to 8 carbon atoms with one or more linear dicarboxylic acids having from 2 to 12 carbon atoms. Linear polyester polyols can also be obtained from linear hydroxycarboxylic acids or unsubstituted lactones. In linear hydroxycarboxylic acids, the hydroxyl group and the terminal carboxyl group are separated by a linear unsubstituted alkyl chain.

According to the present invention, the optional linear polyester polyols are selected from the polycarboxylic acids and polyols as above so long as both of the polycarboxylic acids and polyols are linear, i.e. have purely linear chains, e.g., linear alkyl having from 2 to 20 carbon atoms, preferably from 2 to 8 carbon atoms in the structure. In one particularly preferred embodiment, the optional linear polyester polyol is obtained from the reaction products of reactants selected from the group consisting of adipic acid, 1,4-butanediol; sebacic acid, 1,4-butanediol; 1,12-dodecandicarboxylic acid, 1,4-butanediol; and adipic acid, ethylene glycol, 1,4-butanediol.

Commercially available linear polyester polyols which may be used in the present invention include, but are not limited to, Dynacoll 7360 (from EVONIK), Fomrez 66-32 (from Crompton) and Rucoflex S-105-30 (from Bayer), XCP-2000H (from XUCHUAN) and so on. While the linear polyester polyols can be purchased from commercial sources, they also can be synthesized by means of conventional processes well known to a person skilled in the art.

According to the present invention, the linear polyester polyol is optionally present in the reactants in an amount of from about 20% to about 60% by weight, preferably from about 30% to about 50% by weight, based on the total amount of the reactants for polyurethane prepolymer.

In still another embodiment, the reactants may further comprise from 0 to about 10%, more preferably from 0 to about 5% by weight of a polyalkylene glycol based on the total weight of said polyurethane prepolymer, even more preferably comprise essentially no polyalkylene glycol, and most preferably comprise no polyalkylene glycol, e.g. polypropylene glycol.

As used herein, the term “essentially no reactant c)/polyalkylene glycol/polyether polyol” refers to that the amount of reactant c)/polyalkylene glycol/polyether polyol contained in the reactants of polyester polyols is for example no more than 1%, 0.9%, 0.8%, 0.7%, 0.6%, 0.5%, 0.4%, 0.3%, 0.2%, 0.1% or 0.05% by weight based on the total weight of the adhesive composition. The polyalkylene glycol/polyether polyol may be present in the adhesive composition as the unavoidable impurity or content of reactants. Preferably, the reactants of the polyurethane prepolymer contain no polyalkylene glycol/polyether polyol. Examples of polyalkylene glycol/polyether polyol are polyethylene glycol, polytetramethylene glycol and polypropylene glycol.

As used herein, the term “polyether polyol” refers to a compound containing the polyoxyalkylene (often referred to as polyether) and one or more side chain hydroxyl groups of the molecule.

As used herein, the term “polyalkylene glycol” is understood to be a linear polyether having 2 OH groups with the general formula HO(—R—O)ₘ—H, wherein R is a hydrocarbon residue having from 2 to 12 carbon atoms. Similarly, copolymers are possible, namely, both block copolymers and random copolymers. Specific polyalkylene glycols may be polyethylene glycol, polytetramethylene glycol and, in particular, polypropylene glycol.

The applicant surprisingly found that the presence of a significant amount, e.g. more than 10% by weight of polyalkylene glycol/polyether polyol in the reactants may cause unacceptable malodor produced from the adhesives due to the existence of small amount of propionic aldehyde as byproduct during the manufacturing of polyalkylene glycol/polyether polyol, especially polypropylene. For example, if neopentyl glycol is used in the production of the polyurethane prepolymer, the free neopentyl glycol will react with propionic aldehyde to give 2-ethyl-5,5-dimethyl-1,3-dioxane (EDMD) which has an odor threshold as low as 5-15 ng/l. Therefore, the reactive polyurethane hot melt adhesive composition according to the present invention will not generate unacceptable malodor which can be detected by human smelling.

The reactive polyurethane hot melt adhesive composition according to the present invention has a Brookfield viscosity of from about 10000 to about 30000 cps, preferably from about 15000 to about 20000 cps at 120° C. measured according to ASTM 1084-1997 by a Brookfield viscometer RVDVII equipped with a Thermosel heating unit using spindle 27 at from 2.5 to 10 rpm.

While the adhesives may be used directly as described above, if desired, the adhesives of the present invention may also be formulated with conventional additives which are compatible with the composition. Such additives include defoamers, plasticizers, compatible tackifiers, curing catalysts, dissociation catalysts, fillers, rheology modifiers, anti-oxidants, pigments, adhesion promoters, stabilizers, aliphatic C₅-C₁₀ terpene oligomers and the like. Conventional additives that are compatible with a composition according to this invention may simply be determined by combining a potential additive with the composition and determining if they are compatible. An additive is compatible if it is homogenous within the product. Non-limiting examples of suitable additives include, without limitation, rosin, rosin derivatives, rosin ester, aliphatic hydrocarbons, aromatic hydrocarbons, aromatically modified aliphatic hydrocarbons, terpenes, terpene phenol, modified terpene, high molecular weight hindered phenols and multifunctional phenols such as sulfur and phosphorous-containing phenol, terpene oligomers, paraffin waxes, microcrystalline waxes and hydrogenated castor oil. The reactive polyurethane hot melt adhesive of the invention may also contain flame retardant reactants.

Generally, the reactive polyurethane hot melt adhesive composition according to the present invention are useful for bonding articles composed of a wide variety of substrates (materials), including but not limited to wood, metal, polymeric plastics, glass and textiles. As such, these adhesives find particular use in applications such as use for bonding to exterior surfaces, bonding to wood with high levels of pitch and e.g., in marine and automotive applications. Other non-limiting uses include textile bonding applications (carpet and clothing), use in the manufacture of in the manufacture of footwear and garments, preferably in the manufacture of footwear and garments, use as a glazing/backbedding compound in the manufacture of windows, use in the manufacture of doors including entry doors, garage doors and the like, use in the manufacture of architectural panels, use in bonding reactants on the exterior of vehicles, and the like, preferably in the manufacture of footwear and garments.

Specifically, due to such advantageous characteristics, the hot-melt adhesives of the invention are suited preferably for use in the footwear or garment industry, particularly in coating machines integral in the shoe production line not including a pre-crosslinking stage using steam or a drying channel.

In one embodiment, the present invention also provide a footwear or garment comprising a cured adhesive obtained from the reactive polyurethane hot melt adhesive according to the present invention.

The hot-melt adhesives of the invention are particularly suitable for attaching soles to shoe uppers, and moreover, for attaching substrates under tension and for leather bonding as well.

Therefore, the invention relates to the use of the adhesives of the invention in binding materials, e.g. soles and shoe upper material, in particular, of leather, using the following processing steps:

i) applying the reactive hot melt adhesive composition according to the present invention in a liquid form to the first substrate;

ii) bringing a second substrate in contact with the composition applied to the first substrate; and

iii) allowing the reactive hot melt adhesive composition to cure by moisture.
Conveniently, prior to coating the hot-melt adhesive of the invention, sole or shoe upper material are pretreated. This involves known methods such as roughing, solvent-wiping or priming using a primer, or halogenation of certain rubber reactants.

Preferably, the adhesive is coated in a thickness of from 0.05 to 0.7 mm using a coating machine. Following coating of one layer of hot melt adhesive and prior to pressing together the surfaces to be bonded, the hot melt adhesive may also be cooled and the pre-finished material may be stored as long as final curing is avoided. Prior to pressing together, the sample must be re-heated at 110 to 180° C. in case that the adhesive was applied to only one substrate, and at 50° to 100° C. in case that both substrates were coated with adhesive.

Final curing may be carried out using various conditions. In particular, curing is achieved through action of airborne moisture where the relative humidity should not be greater than 25% at 20° C. Under these conditions, the final curing will take at least 24 hours. However, ambient conditions may also vary, e.g., in the range of 20±5° C. Nevertheless, relative humidity should not be below 10% to obtain final curing within a period of from 3 to 7 days.

Accordingly, in another aspect, the present invention is also directed to a cured adhesive obtained from the reactive polyurethane hot melt adhesive composition and a coated substrate which is coated on at least one surface with the reactive polyurethane hot melt adhesive composition in the present invention, which is finally cured from the polyurethane prepolymer.

The composition is typically distributed and stored in its solid form, and is stored in the absence of moisture. When the composition is ready for use, the solid is heated and melted prior to application. Thus, this invention includes reactive polyurethane hot melt adhesive compositions in both its solid form, as it is typically to be stored and distributed, and its liquid form, after it has been melted, just prior to its application.

By using the reactive polyurethane hot melt adhesive composition according to the present invention, the final cured adhesive possesses good elasticity, good recovery, high initial tack and good hydrolysis resistance.

In one embodiment, the final cured adhesive obtained from the reactive polyurethane hot melt adhesive composition according to the present invention has elasticity from about 95 to about 150 gf/8mm, preferably about 100 to about 130 gf/8mm and recovery about 80% to about 99% according to the testing method as shown below.

### EXAMPLE

The following examples illustrate the invention and are not intended to limit the same.
Materials:
Polycarboxylic acid:
AA: adipic acid, commercially available from Evonik;
IPA: isophthalic acid, commercially available from Evonik;
PA: phthalic acid, commercially available from Evonik; and
TPA: terephthalic acid, commercially available from Evonik.
Polyols:
DEG: dietheylene glycol, commercially available from Xuchuan chemical industrial Co. Ltd.;
BD: 1,4-butanediol, commercially available from Xuchuan chemical industrial Co. Ltd.; and
NPG: neopentyl glycol, commercially available from Xuchuan chemical industrial Co. Ltd.
EG: ethylene glycol, commercially available from Xuchuan chemical industrial Co. Ltd.
Polyisocyanate:
MDI: 4′4-methylenebisphenyldiisocyanate, commercially available from Bayer.

### Example 1 (Comparative)

Reactive hot melt adhesives having the formulations shown in Table 1 (% by weight) were prepared. All the polyols and polycarboxylic acids were added in a reactor to melt and mix under vacuum, and dehydrated for about 2 hrs at 120° C. Then MDI was added and polymerization allowed to proceed with mixing under vacuum for about 2 hrs until reaction was complete. The resulting prepolymer was then placed into a container under a dry nitrogen headspace to prevent exposure to moisture. The NCO/OH ratio of the product is 2.0, Brookfield viscosity is 4000 cps at 120° C. and NCO content is 4.05% by weight.

TABLE 1
The composition of Example 1

| | | Amount | OH | NCO Content | Weight |
|---|---|---|---|---|---|
| Reactant | Structure | (wt %)* | Value | (wt %) | (wt %)** |
| Polyester | AA | 55 | 112 | | 25 |
| polyol A | DEG | 45 | | | |
| Polyester | AA | 60 | 56 | | 25 |
| polyol B | EG | 40 | | | |
| Polyester | AA | 55 | 56 | | 25 |
| polyol C | BD | 45 | | | |
| Isocyanate | MDI | | | 33.6 | 25 |

*“Amount” refers to the amount of polyol(s) and polycarboxylic acid(s) for preparing the polyester polyols.
**“Weight” refers to the weight of the polyester polyols and isocyanate for preparing the prepolymers.

### Example 2 (Inventive)

Reactive hot melt adhesives having the formulations shown in Table 2 (% by weight) were prepared. All the polyols and polycarboxylic acids were added in a reactor to melt and mix under vacuum, and dehydrated for about 2 hrs at 120° C. Then MDI was added and polymerization allowed to proceed with mixing under vacuum for about 2 hrs until reaction was complete. The resulting pre-polymer was then placed into a container under a dry nitrogen headspace to prevent exposure to moisture. The NCO/OH ratio of the product is 2.0, Brookfield viscosity is 20000 cps at 120° C. and NCO content is 2.48% by weight.

TABLE 2
The composition of Example 2

| | | Amount | OH | NCO content | Weight |
|---|---|---|---|---|---|
| Reactant | Structure | (wt %) | value | (wt %) | (wt %) |
| Polyester | AA | 57 | 36.5 | | 28 |
| polyol A | IPA | 13 | | | |
| | EG | 30 | | | |
| Polyester | PA | 60 | 58 | | 28 |
| polyol B | NPG | 40 | | | |
| Polyester | AA | 60 | 33.5 | | 28 |
| polyol C | IPA | 13 | | | |
| | BD | 27 | | | |
| Isocyanate | MDI | | | 33.6 | 16 |

### Example 3 (Inventive)

Reactive hot melt adhesives having the formulations shown in Table 3 (% by weight) were prepared. All the polyols and polycarboxylic acids were added in a reactor to melt and mix under vacuum, and dehydrated for about 2 hrs at 120° C. Then MDI was added and polymerization allowed to proceed with mixing under vacuum for about 2 hrs until reaction was complete. The resulting pre-polymer was then placed into a container under a dry nitrogen headspace to prevent exposure to moisture. The NCO/OH ratio of the product is 2.0, Brookfield viscosity is 10000 cps at 120° C. and NCO content is 3.35% by weight.

TABLE 3
The composition of Example 3

| | | Amount | OH | NCO content | Weight |
|---|---|---|---|---|---|
| Reactant | Structure | (wt %) | value | (wt %) | (wt %) |
| Polyol A | AA | 60 | 56 | | 34 |
| | EG | 40 | | | |
| Polyol B | IPA | 30 | 35 | | 30 |
| | TPA | 25 | | | |
| | BD | 45 | | | |
| Polyol C | PA | 60 | 116 | | 15 |
| | NPG | 40 | | | |
| Isocyanate | MDI | | | 33.6 | 21 |

### Example 4 (Comparative)

Reactive hot melt adhesives having the formulations shown in Table 4 (% by weight) were prepared. All the polyols, polyalkylene glycol (PPG 400, which is a propylene glycol having a molecular weight of about 400, commercially available from Dow Chemical) and polycarboxylic acids were added in a reactor to melt and mix under vacuum, and dehydrated for about 2 hrs at 120° C. Then MDI was added and polymerization allowed to proceed with mixing under vacuum for about 2 hrs until reaction was complete. The resulting pre-polymer was then placed into a container under a dry nitrogen headspace to prevent exposure to moisture. The NCO/OH ratio of the product is 1.5, Brookfield viscosity is 7500 cps at 120° C. and NCO content is 2.5% by weight.

TABLE 4
The composition of Example 4

| | | Amount | OH | NCO content | Weight |
|---|---|---|---|---|---|
| Reactant | Structure | (wt %) | value | (wt %) | (wt %) |
| Polyol A | AA | 60 | 56 | | 21.6 |
| | EG | 40 | | | |
| Polyol B | IPA | 30 | 35 | | 27.7 |
| | TPA | 25 | | | |
| | BD | 45 | | | |
| Polyol C | PA | 60 | 116 | | 16.2 |
| | NPG | 40 | | | |
| Polyalkylene | PPG 400 | | 280 | | 10.8 |
| glycol | | | | | |
| Isocyanate | MDI | | | 33.6 | 23.7 |

Evaluation

The performance of the products obtained from Examples 1 to 4, including elasticity, recovery, initial tack and odor were tested and summarized in Table 5. The testing methods for evaluation are listed as below.
Testing Methods:
Elasticity

The testing method of the elasticity of the cured product is composed of the steps as follows:
1. Preparing a cured sample having about 8 mm width, about 10 cm length and about 0.05 mm thickness obtained from the reactive polyurethane hot melt adhesive compositions in Examples 1 to 4;
2. making points A and B with marks on the surface of the cured sample, wherein the line between A and B is parallel to the longitude direction of the cured sample film, and the distance between A and B is about 5 cm, and
3. recording the loading strength in gf/8mm when the sample was stretched on a tensile machine in the longitude direction to extend the distance between A and B from 5 cm to 9 cm (i.e. by 80%).
Recovery

The testing method of the recovery of the cured product is composed of the steps as follows:
1. Preparing a cured sample having about 8 mm width, about 10 cm length and about 0.05 mm thickness obtained from the reactive polyurethane hot melt adhesive compositions in Examples 1 to 4;
2. making points A and B with marks on the surface of cured sample, wherein the line between A and B is parallel to the longitude direction of the cured sample film, and the distance between A and B is about 5 cm;
3. stretching the cured sample on a tensile machine in the longitude direction to extend the distance between A and B from 5 cm to 9 cm (i.e. by 80%);
4. holding about 60 sec, and then removing the cured sample from the tensile machine;
5. measuring the distance between points A and B in mm, and calculating the recovery from the formula:
Recovery (%)=[(40-the distance measured in step 5)/40 ]×100
Viscosity

The viscosity is measured according to ASTM 1084-1997 by a Brookfield viscometer RVDVII equipped with Thermosel heating unit using spindle 27 at from 2.5 to 10 rpm at 120° C.
Initial tack

The initial tack is measured according to ASTM D2724-1987 by coating 0.05mm thickness of glue between two PET film layers, and after 5 minutes measuring the loading strength by a tensile machine.

Odor

The odor test is measured by the following methods: Methods 1:
1. Coat a hot melt adhesive composition onto a substrate, and obtain an adhesive film;
2. Place the adhesive film in a glass can;
3. Put this glass can in an oven heated to 120° C. for 1 hr to melt the adhesive film; and
4. Open the cover of the glass can and smell whether there is an unpleasant odor (malodor).
Method 2:
1. Coat a hot melt adhesive composition onto a substrate, and obtain an adhesive film;
2. Place the adhesive film into a re-sealable plastic bag and keep it sealed and curing in the plastic bag; and
3. After 3 days, open the plastic bag and smell whether there is an unpleasant odor.

TABLE 5
The result of evaluation

| | Elasticity | Recovery | Initial tack | |
|---|---|---|---|---|
| Example | (gf/8 mm) | (%) | (gf/in) | Malodor |
| 1 | 25 | 70 | 150 | No* |
| 2 | 250 | 81.5 | 2250 | No* |
| 3 | 110 | 98.5 | 1950 | No* |
| 4 | 35 | 55 | 350 | Strong** |

*No malodor measured by both of methods 1 and 2.
**Strong malodor measured by both of methods 1 and 2.

As shown in Table 5, compared to the products of Example 1 which were completely produced from polyester polyols having linear structures, products of Examples 2 and 3 of the present invention having non-linear structures exhibited better elasticity, better recovery and higher initial tack.

In addition, compared to the products of Example 4 which produced from the compositions having more than 10% by weight of PPG based on the total weight of the prepolymer, products of Examples 2 and 3 of the present invention which have branched and cyclic structures and contain no PPG surprisingly exhibited much better performance in elasticity, recovery and initial tack.

In addition, the cured products of Examples 1 to 3 having no PPG did not release any malodor that could be smelled. However, the product of Example 4 having more than 10% by weight of PPG and NPG produced a strong malodor, which is unpleasant to the user of the hot melt adhesive product.

Moreover, the adhesive products according to the present invention also have good hydrolysis resistance. They exhibited no delamination and wrinkle in the test according to AATCC 135-2000 by laundry 20 times in 40° C. hot water.

These and other modifications and variations of the present invention may be practiced by those of ordinary skill in the art, without departing from the spirit and scope of the present invention. In addition, it should be understood that aspects of the various embodiments may be interchanged both in whole or in reactant. Furthermore, those of ordinary skill in the art will appreciate that the foregoing description is by way of example only, and is not intended to limit the invention so further described in such appended claims.

What is claimed is:

1. A reactive polyurethane hot melt adhesive composition comprising at least one polyurethane prepolymer, said polyurethane prepolymer including the reaction product of a mixture comprising:
a) at least one polyisocyanate,
b) at least one non-linear polyester polyol, and
c) from 0 to 10% by weight of a polyalkylene glycol based on the total weight of said polyurethane prepolymer.

2. The reactive polyurethane hot melt adhesive composition according to claim 1, wherein the mixture contains essentially no polyalkylene glycol or polyether polyol.

3. The reactive polyurethane hot melt adhesive composition according to claim 1, wherein the NCO/OH ratio is from 1.7 to 2.2.

4. The reactive polyurethane hot melt adhesive composition according to claim 1, wherein the polyurethane prepolymer has a NCO content of from 1.0 to 3.0% by weight, based on the total weight of the polyurethane prepolymer.

5. The reactive polyurethane hot melt adhesive composition according to claim 1, wherein the at least one polyisocyanate is a diisocyanate selected from the group consisting of methylenebisphenyldiisocyanate, isophoronediisocyanate, hydrogenated methylenebisphenyldiisocyanate and toluene diisocyanate or a combination thereof.

6. The reactive polyurethane hot melt adhesive composition according to claim 1, wherein the at least one non-linear polyester polyol is a reaction product of one or more polyols having from 2 to 8 carbon atoms with one or more polycarboxylic acids having from 2 to 12 carbon atoms, in which at least one of the polyols or polycarboxylic acids is non-linear.

7. The reactive polyurethane hot melt adhesive composition according to claim 6, wherein:
the polyol having from 2 to 8 carbon atoms is selected from 1,2-propanediol, 1,3-butanediol, 1,2-butanediol, 1,2-pentanediol, 1,3-pentanediol, 1,4-pentanediol, pentanetriol, hexanetriol, octanetriol, trimethylolpropane, pentaerythritol, 2-ethylhexanediol -1,4, cyclohexanediol-1,4, neopentyl glycol, methylpentanediol, naphthalenediol, benzenediol, and mixtures thereof; and/or
the non-linear polycarboxylic acid has from 6 to 12 carbon atoms and is selected from phthalic acid, isophthalic acid, terephthalic acid, tetrachlorophthalic acid, dodecylmaleic acid, octadecenylmaleic acid, aconitic acid, trimellitic acid, tricarballylic acid, cyclohexane-1,2-dicarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters, and mixtures thereof.

8. The reactive polyurethane hot melt adhesive composition according to claim 6, wherein at least one of the non-linear polycarboxylic acid is an aromatic dicarboxylic acid and/or the at least one non-linear polyol is a non-linear aliphatic diol, preferably neopentyl glycol.

9. The reactive polyurethane hot melt adhesive composition according to claim 6, wherein at least one of the non-linear polycarboxylic acid is selected from the group consisting of phthalic acid, isophthalic acid, terephthalic acid or a combination thereof, and/or the at least one non-linear polyol is neopentyl glycol.

10. The reactive polyurethane hot melt adhesive composition according to claim 1, wherein the mixture further comprises d) at least one linear polyester polyol, wherein the at least one linear polyester polyol is a reaction product of at least one linear diol having from 2 to 8 carbon atoms with at least one linear dicarboxylic acid having from 2 to 12 carbon atoms.

11. The reactive polyurethane hot melt adhesive composition according to claim 10, wherein:
the linear diol having from 2 to 8 carbon atoms is selected from ethylene glycol, diethylene glycol, 1,3-propanediol, 1,4-butanediol, 1,5-pentanediol, 1,6-hexanediol, and mixtures thereof, preferably ethylene glycol, diethylene glycol, dipropylene glycol, 1,4-butanediol, 1,6-hexanediol, and mixtures thereof; and/or
the linear dicarboxylic acid having from 2 to 12 carbon atoms is selected from adipic acid, pimelic acid, suberic acid, azelaic acid, sebacic acid, 1,11-undecandicarboxylic acid, 1,12-dodecandicarboxylic acid, and the corresponding acid anhydrides, acid chlorides and acid esters, and mixtures thereof.

12. The reactive polyurethane hot melt adhesive composition according to claim 1, wherein the at least one non-linear polyester polyol and/or the optional at least one linear polyester polyol have a hydroxyl value of from 10 to 200.

13. The reactive polyurethane hot melt adhesive composition according to claim 1, wherein the composition comprises:
a) from 10% to 60% by weight of at least one polyisocyanate,
b) from 40% to 90% by weight of at least one non-linear polyester polyol, and
c) from 0 to 10% by weight of a polyalkylene glycol, each based on the total weight of the polyurethane prepolymer.

14. The reactive polyurethane hot melt adhesive composition according to claim 1, wherein the Brookfield viscosity of the hot melt adhesive composition is from 10000 to 30000 cps at 120° C., measured according to ASTM 1084-1997.

15. The reactive polyurethane hot melt adhesive composition according to claim 1 bonded to a substrate comprised of wood, metal, polymeric plastic, glass and textile.

16. Cured reaction products of the reactive polyurethane hot melt adhesive composition according to claim 1 bonded to a substrate comprised of wood, metal, polymeric plastic, glass and textile.

17. A footwear or garment comprising cured reaction products of the reactive polyurethane hot melt adhesive composition according to claim 1.

18. A method of making footwear or garments comprising a first substrate and a second substrate, said method comprising:
i) applying the reactive hot melt adhesive composition according to claim 1 in a liquid form to the first substrate;
ii) bringing a second substrate in contact with the composition applied to the first substrate; and
iii) allowing the reactive hot melt adhesive composition to cure by moisture.
